(19) United States
(12) Patent Application Publication
(10) Pub. No.: US 2018/0174148 A1
(43) Pub. Date: Jun. 21, 2018

(54) SYSTEM AND METHOD FOR USER AUTHORIZED CARD TRANSACTIONS TO PREVENT FRAUD

(71) Applicant: BALAMURUGAN SELVARAJAN, Bangalore (IN)

(72) Inventor: BALAMURUGAN SELVARAJAN, Bangalore (IN)

(21) Appl. No.: 15/379,797

(22) Filed: Dec. 15, 2016

(51) Int. Cl. G06Q 20/40; G06Q 20/34

(52) U.S. Cl. CPC G06Q 20/4018; G06Q 20/401; G06Q 20/34

(57) ABSTRACT

A system and method for a user authorized card transaction to prevent card misuse is presented. The system includes a user modified Control Parameter stored with the Card Issuer, a plurality of interface for the User to enable or disable the Control Parameter and a method for the Card Issuer to accept or decline the Charge based on the status of the Control Parameter. Further, a system and method of real-time replacement of card number for a compromised card using electronic-paper based card is provided.

### BACKGROUND

### Technical Field

The present invention is related to security of credit and debit card transactions. More particularly, this invention relates to preventing card misuse over the network. Specifically, this invention is related to a method of user authorization to prevent unauthorized card transactions.

### Description of Related Art

Loses due to stolen, cloned or misuse of credit and debit card is a serious issue for the financial services industry. Consequently, many a solution has been proposed to mitigate the risk and secure card transactions over the network.

Generally, most of the current solutions involve static information such as CVV or Zip code checks. More advanced solutions exist, but are still Network or Bank initiated authorization, at the point of sale, such as sending the user a one time password or code to be entered during the purchase process.

This invention outlines a novel method for a user of a Card to proactively choose an authorization status, so as to ensure his or her card security and prevent misuse. This invention requires minimal changes to the current systems and processes and is user initiated.

The above-mentioned shortcomings, disadvantages, and problems are addressed herein and which will be understood by reading and studying the following specification.

### SUMMARY OF THE EMBODIMENTS HEREIN

The various embodiments herein provide a system and method for a user initiated and user authorized transaction to prevent card misuse and fraud. Typically, a user will use their card with a Merchant, at a POS machine, online, etc. It is a well known method to reduce fraud by requesting the user to input a CVV or ZIP to additionally validate the card. More recent systems additionally request a One Time Password (OTP)

In case of a Chip card, an additional PIN is used to validate the card at the POS, but not when used online.

In all such cases, the additional security data is collected, used and transmitted at the Point of Sale or Merchant location/communication network, which makes all of these features vulnerable in the face of malicious Card reader, malware or an unscrupulous merchant, deliberately copying the information and cloning the card.

This invention outlines a simple out-of-network, user-initiated control of his or her card status using a Control Parameter to prevent misuse. In one embodiment of the system, the card user “disables” the card when not in use (example, when the user is at his home) by setting the Control Parameter to “false” and later “enables” it before use (at the store, before making a purchase), by setting the Control Parameter to “true”.

This Control parameter set by the user is validated by the Card Issuer along with all existing parameters and processes, to decide if the card should be accepted or declined when a charge is presented by a Merchant. If the Control parameter is “false” (user has disabled the card control), then all charges presented on the card will be declined and a special status of “User Declined” sent over the Network to differentiate this card failure from other reasons, such as No Funds, etc.

The key aspect of this invention is that this is user controlled and set easily and instantly through the web and smart phone, by the user without going through a call center or support personnel. In one embodiment of this invention, the user logs in to his banking account with the Card Issuer, where the Card Control is enabled or disabled, preferably with a single button click.

In another embodiment of this invention, the user downloads and installs a mobile or smartphone app from his Card Issuer on to his phone from which the card is enabled or disabled in real time.

In yet another embodiment of this invention for older phones, an SMS or automated IVR based system is provided to enable or disable the card. The system operates in real time, providing a simple, fast and instantaneous method for the user to enable or disable the card whenever needed.

In one embodiment of the system, a “User Declined” status is sent to the user's registered mobile/smartphone app, which prompts the user to “Enable Transactions” or “Report Misuse”. In case, this was a genuine transaction by the user, he or she would enable and retry the card. In case of a stolen or cloned card situation, the user simply clicks on “Report Misuse” to block the transaction and report it as well.

In another embodiment of the system, the registered mobile app of the user automatically updates the users's location data or timezone in real-time, so that the Network makes an intelligent decision as to the authenticity of the card transaction. Alternately, the user specifies a list of typical usage timings and locations along with the Card Control parameter, which are additionally validated by the Card Issuer in deciding to accept or decline the card.

The various embodiments above, provide a system and method for securing a card transaction and prevent misuse. In the event that a card is cloned or the information is copied, the ability to replace the card number and CVC in real-time would obviate the time, cost and delay involved in generating and shipping a new card. In one embodiment of this invention, the user's card is made using e-paper technology, that displays information even without an active power source. This would enable the user to request and for the Card Issuer to issue a new card number or CVV instantly, over the Network, without having to mail a physical card. Such a re-issue of CVV or card number presupposes identity verification of the user and device, as it is done today and a secure communication mechanism to transmit this information to the e-paper based card, so that it now displays the new card number, along with the expiry date and name. Except at the time of data change, the e-paper does not require an active power source and functions like a typical plastic card.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will be apparent to those skilled in the art from the following description of the preferred embodiment and the accompanying drawings in which:

FIG. 1 illustrates a block diagram of a typical Card processing transaction, according to currently practiced art

FIG. 2 illustrates a block diagram of a user setting the Card Control parameter using a PC or smartphone

FIG. 3 illustrates a block diagram of Card processing according to one embodiment of this invention

FIG. 4 illustrates an electronic paper (e-paper) display based credit or debit card for dynamic allocation and change of card number and CVC.

FIG. 5 illustrates a real time update to the card number, CVC and expiry

Although the specific features of the embodiments herein are shown in some drawings and not in others. This is done for convenience only as each feature may be combined with any or all of the other features in accordance with the embodiments herein.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a system and method for a user initiated and user authorized transaction to prevent card misuse and fraud. Typically, a user will use their card with a Merchant, at a POS machine, online, etc. It is a well known method to reduce fraud by requesting the user to input a CVV or ZIP to additionally validate the card. More recent systems additionally request a One Time Password (OTP). In case of a Chip card, an additional PIN is used to validate the card at the POS, but not when used online.

In all such cases, the additional security data is collected, used and transmitted at the Point of Sale or Merchant location/communication network, which makes all of these features vulnerable to a malicious Card reader, malware or an unscrupulous merchant, deliberately copying the information and cloning the card.

This invention outlines an out-of-network, user-initiated control of his or her card status using a Control Parameter to prevent misuse. In one embodiment of the system, the card user “disables” the card when not in use (example, when the user is at his home) by setting the Control Parameter to “false” and later “enables” it before use (at the store, before making a purchase), by setting the Control Parameter to “true”.

This Control parameter set by the user is validated by the Card Issuer along with all existing parameters and processes, to decide if the card should be accepted or declined when a charge is presented by a Merchant. If the Control parameter is “false” (user has disabled the card control), then all charges presented on the card will be declined and a special status of “User Declined” sent over the Network to differentiate this card failure from other reasons, such as No Funds, etc.

The key aspect of this invention is that this is user controlled and set easily and instantly through the web and smart phone, by the user without going through a call center or support personnel. In one embodiment of this invention, the user logs in to his banking account with the Card Issuer, where the Card Control is enabled or disabled, preferably with a single button click.

In another embodiment of this invention, the user downloads and installs a mobile or smartphone app from his Card Issuer on to his phone from which the card is enabled or disabled in real time.

In yet another embodiment of this invention for older phones, an SMS or automated IVR based system is provided to enable or disable the card. The system operates in real time, providing a simple, fast and instantaneous method for the user to enable or disable the card whenever needed.

In one embodiment of the system, a “User Declined” status is sent to the user's registered mobile/smartphone app (apart from the one sent to the Merchant's POS), which prompts the user to “Enable Transactions” or “Report Misuse”. In case, this was a genuine transaction by the user, he or she would enable and retry the card. In case of a stolen or cloned card situation, the user simply clicks on “Report Misuse” to block the transaction and report it as well.

In another embodiment of the system, the registered mobile app of the user automatically updates the users's location data or timezone in real-time, so that the Network makes an intelligent decision as to the authenticity of the card transaction. Alternately, the user specifies a list of typical usage timings and locations along with the Card Control parameter, which are additionally validated by the Card Issuer in deciding to accept or decline the card.

The various embodiments above, provide a system and method for securing a card transaction and prevent misuse. In the event that a card is cloned or the information is copied, the ability to replace the card number and CVC in real-time would obviate the time, cost and delay involved in generating and shipping a new card. In one embodiment of this invention, the user's card is made using e-paper technology, that displays information even without an active power source. This would enable the user to request and for the Card Issuer to issue a new card number or CVV instantly, over the Network, without having to mail a physical card. Such a re-issue of CVV or card number presupposes identity verification of the user and device, as it is done today and a secure communication mechanism to transmit this information to the e-paper based card, so that it now displays the new card number, along with the expiry date and name. Except at the time of data change, the e-paper does not require an active power source and functions like a typical plastic card.

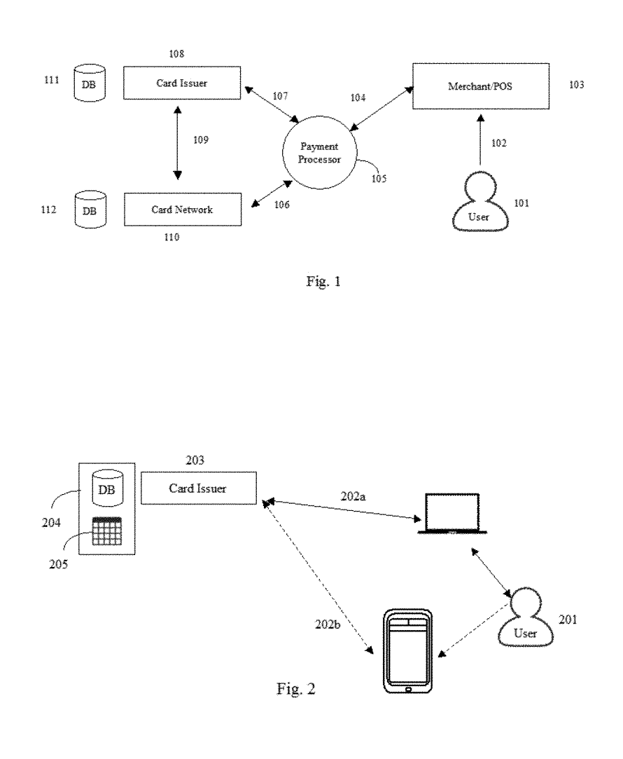

FIG. 1 illustrates a block diagram of a typical Card processing transaction, according to currently practiced art. The user presents the card at the Merchant or POS (102). The Merchant is connected to a Payment Processor (105), who first validates the card with the Card Network provider (110) and to get details of the Card Issuer/Issuing Bank (example of Networks are Visa, Master and Amex). The Payment Processor, then proceeds to communicate with the Card Issuer (108) to request a Charge. If the Charge goes through, the Card Issuer makes the appropriate debit to the card and credit to the payment processor, who in turn credits to the Merchant account.

The Card Issuer maintains the data on the issued card (111), including its outstanding balance, customer information, etc. It is the Card Issuer that finally accepts or declines a charge. It is to be noted that in case of card misuse, the Card Issuer, in most countries, is liable for the fraudulent charge.

In one embodiment of this invention, the Card Control parameter is maintained at the Card Issuer, along with their database of customer and card information like name, zip and expiry (205).

FIG. 2 illustrates a block diagram of a user setting the Card Control parameter using a PC or smartphone at the Card Issuer, at any time prior to an actual transaction. In one embodiment of this invention, the Card Issuer/Issuing Bank provides a link in their home banking page, where the user logins in for banking and proceeds to enable or disable the Card Control parameter. 202a illustrates this process using a PC and 202b illustrates the same process using a smart phone.

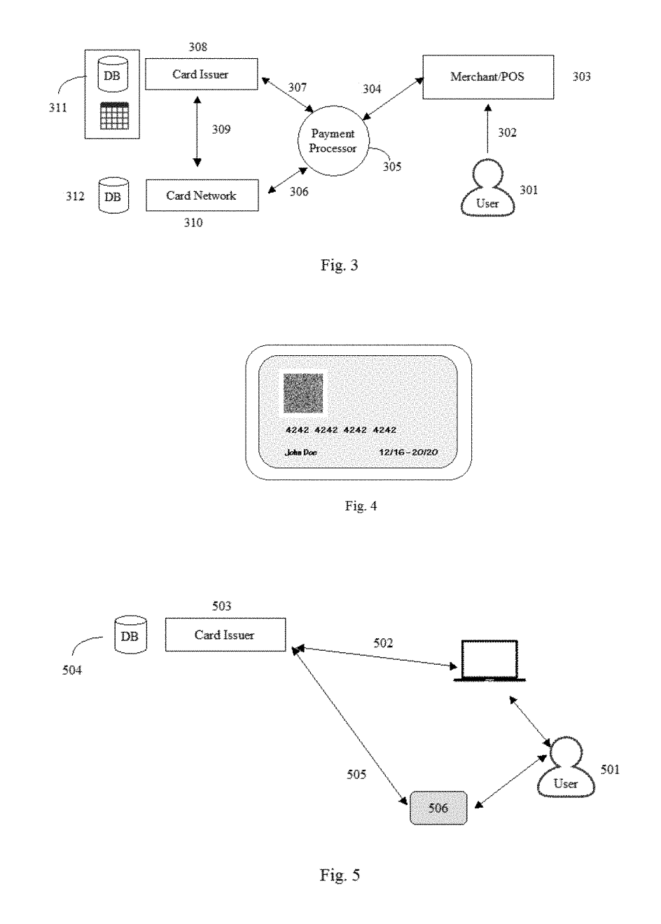

FIG. 3 illustrates a block diagram of Card processing, with the Card Control parameter, according to one embodiment of this invention. The process is very similar to the one shown in FIG. 1, except that the Card Issuer additionally validates the Card Control parameter and accepts the charge if and only of the Card Control parameter is true. To reduce the quantum of change to current systems to accommodate a user authorization, the Card Control parameter is stored as a table extension in an external data store as a tupe (secure_identifier, card_control, augmented_data) and accessed via an external database call or a Web API during the charge process.

In one embodiment of this invention, the Control Parameter is augmented with a list of location information entered by the user, and the Card Issuer additionally verifies if the card usage location matches at least one of the location from the said list before approving a charge. In one embodiment, the location data is continuously and automatically updated from the user's smart phone with the actual location information. In another embodiment, the user enters a list of typical/safe locations through the Card Issuer's banking or mobile interface.

In another embodiment, the Control Parameter is augmented with a list of date and time information and the Card Issuer declines all charge requests outside the specified date and time window. This way, a user can automatically disable all card transactions during the night, or whenever they typically don't expect to be using the card.

FIG. 4 illustrates an electronic paper (e-paper) display based credit or debit card for dynamic allocation and change of card number and CVC. This is especially useful, if the card does get compromised. In one embodiment, a e-paper based card is used to enable the Card Issuer to issue a new card number and CVC (essentially, a new card), in real time, over the network, without the need for dispatching a physical card.

FIG. 5 illustrates one embodiment of a real time update to the card number, CVC and expiry for a e-paper based card explained above.

This invention outlines a system and method for a user authorized card transaction to prevent card misuse, comprising of at least a user modified Control Parameter stored with the Card Issuer/Issuing Bank, a plurality of interface for the card User to enable or disable the Control Parameter and for the Card Issuer to accept or decline the card based on the status of the said Control Parameter

In one, more typical, embodiment of this invention, the Control Parameter and additional data are stored at the Card Issuer. In an alternate embodiment, the Control Parameter and augmented data is stored with the Card Network provider, for the same purpose, and performs the same function.

The interface to set or unset the Control Parameter is typically provided through a Computing Device, selected from a group consisting of smartphone, a laptop, a tablet, a wearable device, or a smart television.

This invention additionally outlines a system and method for a user initiated, real-time update of card number and CVC (or replacement card) to replace a breached card in real time, using an electronic-paper based card in place of a plastic card. The user then request the Card Issuer for a replacement and the Issuer generates in real time, a new card number, expiry and CVC and transmits the said data securely to the e-paper based card. The e-paper based card is then reprogrammed to display the new card number, CVC and expiry date

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims

I claim:

1. A system and method for a User authorized card transaction to prevent card misuse, comprising:
A User modified Control Parameter stored with the Card Issuer
An interface for the User to enable or disable the said Control Parameter
A system for the Card Issuer to accept or decline the card based on the status of the said Control Parameter

2. The system according to claim 1, wherein the interface to set the Control Parameter is provided through a Computing Device, selected from a group consisting of smartphone, a laptop, a tablet, a wearable device, or a smart television.

3. The system according to claim 1, wherein the Control Parameter is augmented with a list of location information and the Card Issuer additionally verifies if the card usage location matches at least one of the location from the said list before approving a charge

4. The system according to claim 1, wherein the Control Parameter is augmented with a list of date and time information and the Card Issuer declines all charge requests outside the specified date and time window

5. The system according to claim 3, where the augmented list of locations is automatically set by an app running on the User's smart phone, based on the actual user location

6. A computer implemented method comprising instructions stored on a non-transitory computer-readable storage medium and executed on a computing device with a hardware processor and a memory for securing a card based transaction, comprising
A plurality of data stored at the Card Issuer, such data at least includes a user modifiable Control Parameter
A plurality of methods for a user to set or unset the Control Parameter at any time prior to a card transaction
A method for the Card Issuer to accept or decline the charge, based on the Control Parameter

7. The system according to claim 1, where the Control Parameter is stored and validated by the Card Network Provider

8. The system according to claim 6, where the plurality of augmented data is stored and validated at the Card Network Provider

9. A system and method for a user initiated, real-time update of card number and CVC, comprising
Issuing an electronic-paper based card in place of a plastic card
A plurality of interfaces for a user to request a new card number
Real time generation of the new card number, expiry and CVC by the Card Issuer
Transmitting the said data securely over a communication network to the said e-paper based card and updating it to display the new card number, CVC and expiry date
